(19) United States
(12) Patent Application Publication
(10) Pub. No.: US 2004/0115378 A1
(43) Pub. Date: Jun. 17, 2004

(54) Apparatus and method for the controlled release of chemical additives

(75) Inventors: Weyman H. Dunaway, The Woodlands, TX (US); Brian A. Butler, Tomball, TX (US); Michael F. Adkins, Houston, TX (US); Reza Talabi, Houston, TX (US)

Correspondence Address: D'AMBROSIO & ASSOCIATES, P.L.L.C., 10260 WESTHEIMER, SUITE 465, HOUSTON, TX, 77042, US

(73) Assignee: Tetra Technologies, Inc.

(21) Appl. No.: 10/320,301

(22) Filed: Dec. 16, 2002

(51) Int. Cl. B32B 1/02

(52) U.S. Cl. 428/35.4

(57) ABSTRACT

An apparatus and method for the controlled release of chemical additives within piping and wellbores. The apparatus is a water dispersible container that controls the release of one or more chemical additives such as corrosion inhibitors, oxygen scavengers, or biocides. The dispersible container is comprised of polyvinyl alcohol chains. The selection of the chains is determined by the application of the container and includes short-chained cold water soluble polyvinyl alcohols, long-chained hot water soluble polyvinyl alcohols, or vinyl alcohol co-polymers. In the method for the controlled release of chemical additives, the container is placed in a pipe or tank for circulation throughout a wellbore. Alternatively, the container is placed in a cap for a subsea well bore.

### FIELD OF THE INVENTION

The present invention relates to an apparatus and method for the controlled release of chemical additives. More particularly, the invention relates to an apparatus and method for the controlled release of downhole chemical additives.

### BACKGROUND OF THE INVENTION

In the petroleum production industry, producing wells range from several hundred feet to over 20,000 feet in depth. Frequently, it is essential to place chemical additives at or near the bottom of the wellbore or in piping leading to and from the wellbore for protection of the hardware and to prevent bacteria growth, scaling, and precipitation that hinder well recovery efforts.

Chemical additives are used to facilitate the production process at various stages of production, from the initial drilling to the plugging and reworking of a well. These additives include downhole corrosion inhibitors to protect steel piping and fittings from corrosion and prolong their service life, emulsion breakers (separates water from oil), flocculants (water clarifier), scale inhibitors and biocides to inhibit microbes that metabolize metals or produce corrosives. These chemical additives are added to water or other fluids that are injected into a well to enhance oil recovery.

At times, production wells are no longer producing, they are either temporarily abandoned or waiting for the next phase of production. In nonproducing wells, the wellbore is often plugged. Precipitation and accumulation in the well of biomasses, scales, oxidizers, and other harmful agents may interfere with reaccessing the wellbore for future production. Chemical additives must be placed within the wellbore during the plugging phase to minimize the harmful effects of precipitation and the accumulation of biomasses, corrosive and oxidizing agents.

Many of the prior methods of adding chemicals to a well or piping cause immediate spiking of the chemical at the time of delivery or insufficient chemical concentrations for the chemical to be effective during the periods between dosing. The current methods of dosing with chemicals near or at the bottom of a wellbore include simple methods of throwing buckets of dry or liquid chemicals downhole, pushing a plug of the fluid down the well, thereby displacing fluid in the wellbore and more complex methods of adding chemicals are suspended in a small diameter tube, often called a coiled tube, down the well, and pushing the fluid down this coiled tube. Both methods have significant disadvantages. Chemicals may be consumed too quickly, also the chemical may be absorbed or react with parts or elements in transit to the wellbore. Often, significant amounts of fluid and matter suspended in the wellbore are displaced into the producing formation, which is undesirable. Many companies in the industry use coiled tubing to solve many of these problems, but the costs and risks of hanging a small diameter tube into a wellbore are quite substantial. Additionally, the coiled tubing frequently suffers severe corrosion.

Solid chemical additives are many times displaced as a slurry into the bottom of the well. Consequently, many of the problems identified with injecting fluids are present. With deep offshore wells, remotely operated vehicles are used to pump chemical additives to the wellbore. The chemicals must survive in concentration throughout the long hoses connecting the wellbore to the vehicles. This process is cumbersome and expensive because of chemical losses and operator down time.

Another method calls for coating a chemical in some form of protective coating and then allowing the chemical to fall, or be displaced at predetermined locations in the well. The coating is a soap, which is used to help foam a well to increase the effect of gas lift. Prior art methods of insulating the soap solids during transit down a well is by encapsulating the soap in wax. The encapsulated soap is then placed downhole, where the wax melts as the temperature increases.

In certain wells, particularly deep, hot wells, wax encapsulation is not appropriate. For instance, it is oftentimes desirable to position a foaming soap at the base of a deep well. The wax will often melt before the chemicals reach the base causing premature displacement of the chemicals. As a rule, the deeper the well, the hotter the bottomhole temperature. In the alternative, when fluids have been circulated to the base of the wellbore or displaced into the producing formation, the wellbore is cooled causing the wax to melt too soon for proper chemical release. Additional problems with wax includes insufficient mechanical strength and waxes are easily chafed off of an encapsulated chemical solid.

U.S. Pat. No. 6,451,750 B2 to Hewitt et al. describes a water soluble package formed from a copolymeric polyvinyl alcohol film for containing a liquid cleaning composition. U.S. Pat. No. 6,306,210 B1 Miksic et al. discloses a technique for adding migrating corrosion inhibitors to raw concrete, including a technique for adding inhibitors to raw concrete mixes. Patent '210 utilizes a water soluble envelope or bag into which corrosion inhibitors are packaged, the bag along with its contents are added to concrete mixes, including mixes in the process of being blended.

WO93/08095 discloses a water soluble or water dispersible package containing a composition such as pesticides or herbicides. The application also discloses a process for producing such a package. The application teaches that a package containing a toxic composition wherein the package comprises a first sheet of non-planar water soluble or dispersible material, a second sheet of water soluble or dispersible material superposed on the first sheet and sealed to it by a continuous closed water soluble or dispersible heat seal along a substantially planar continuous region of the superposed sheets, and a third sheet between the first and second sheets and joined to them along the continuous closed water soluble heat seal, whereby the third sheet divides the package into two sealed compartments which open on exposure of the package to water. The water soluble package minimizes the possibility of accidental contact with the environment or humans.

EP89308058.0 discloses a process for addition of powdered substances, such as powdered carbon, to waste water. The powdered substance is packaged in a water soluble container. The application teaches that the entire package is introduced into a liquid medium where it floats on the surface. The underside contacting the liquid dissolves first and the powdered carbon is progressively dispersed into the liquid while the upper surface of the package prevents release of the powdered substance to the surrounding environment. The application suggests that the water soluble package be made of a polyvinyl alcohol.

WO92/17382 discloses a package containing an agrochemical composition which the package comprises a first sheet of non-planar water soluble or water dispersible material defining a concavity enclosing the agrochemical composition and a second sheet of water soluble or water dispersible material sealed to the first sheet by a continuous closed water soluble or water dispersible seal. The application defines agrochemicals as pesticides and herbicides in an organic liquid or solid form.

U.S. Pat. No. 6,279,656 to Sinclair et al. describes a method of treating a well, a formation, or both, with the solids, liquids, or apparatuses, by 1) encasing the solids, liquids, or apparatuses in a water-soluble shell, 2) conveying the encased solids, liquids, or gases to a predetermined location in the well, and then 3) allowing the water-soluble shell to dissolve in the aqueous phase in the wellbore. The shell consists of a water-soluble polymer and, a crosslinking agent such as zolidine. Optionally, a hydrophobic compound such as a processed oil and water is used in processing. Patent '656 teaches that the encased materials may also be apparatuses, such as a prefabricated screen completion or a prefabricated sand-pack.

U.S. Pat. No. 3,971,852 to Brenner et al. describes a process for encapsulating various fragrance oils such as oils with citrus and spice odors. The oils are encapsulated in a matrix comprised of polysaccharide and polyhydroxy compounds by converting an emulsion of the fragrance oil droplets in a solution of the matrix ingredients to an encapsulated solid state during a spray drying process. The patent also mentions that miscellaneous chemicals can be encapsulated by the invention method such as drilling fluids and waxes. U.S. Pat. No. 4,269,279 to House discloses the use of plastic coated magnetic particles in a bead form to increase lubrication for drilling fluids. The encapsulated ferromagnetic particles can be recovered for reuse with a magnetic separator.

U.S. Pat. No. 4,036,301 to Powers et al. describes an encapsulated material useful in cementing a well, wherein a cement accelerator is encapsulated in a waxy material and placed within a highly retarded cement slurry. The cement slurry is pumped into the well with the encapsulated accelerator. After proper placement of the cement, circulation is decreased so that the temperature of the cement fluid approaches the bottom hole temperature of the well and melts the encapsulated material, freeing the accelerator which sets the cement.

What is needed is a chemical delivery system that provides mechanical strength and that can insulate solid and liquid chemical additives during transit within piping and down to a wellbore without decomposing prematurely, or leaving residual debris.

### SUMMARY OF THE INVENTION

As the length of wellbores increases with new production methods, horizontal drilling or deep sea drilling for example, the task of delivering chemicals down long wellbores becomes increasingly difficult. The apparatus and method of this invention controls the release of chemical additives as they are transported to a final site that may be up to several miles from the insertion point. Consequently, the chemicals additives within the apparatus of this invention are timely released at their final destination in the concentrations necessary for them to be effective.

In one aspect, the present invention is an apparatus for the controlled release of one or more downhole chemical additives within piping and wellbores. Preferably, the apparatus comprises one or more downhole chemical additives enclosed within a water dispersible container. For illustration rather than limitation, the downhole chemical additives can be selected from corrosion inhibitors, oxygen scavengers, biocides, tracers, hydrate inhibitors, breakers, scale inhibitors, emulsion preventers, foamers, defoamers, temporary plugging agents, iron reducing agents, iron chelators, metal chelators, or combinations thereof. The water dispersible container preferably comprises polyvinyl alcohol chains, short-chained cold water soluble polyvinyl alcohols, long-chained hot water soluble polyvinyl alcohols or vinyl alcohol co-polymers.

Polyvinyl alcohol is selected as the material for the controlled release container because it is water dispersible and semi-permeable. When placed in water, the water diffuses into the container causing the container to swell and to disperse the particles of polyvinyl alcohol thereby allowing the release of the chemical additives. The time period for dispersement can be controlled by selecting either long-chained or short-chained polyvinyl alcohols.

In one preferred embodiment, the water dispersible container comprises a first sheet of water dispersible material sealed to a second sheet of water dispersible material wherein the downhole chemical additive is contained between the first and second sheets. In an alternate embodiment, the downhole chemical additive is in a solid geometric shape, for example a tablet, rectangle or sphere, and the water dispersible polyvinyl alcohol is a film formed onto the solid chemical additive. In still another alternative, the water dispersible container is a matrix formed onto a substrate embodying a rod. The matrix comprises a mixture of a downhole chemical additive and polyvinyl alcohol.

In one aspect, the present invention provides an apparatus for the controlled release of downhole chemical additives enclosed within a water soluble container comprised of polyvinyl alcohol chains, short-chained cold water soluble polyvinyl alcohols, long-chained hot water soluble polyvinyl alcohols, or vinyl alcohol co-polymers. The container can be formed from two sheets of water soluble polyvinyl alcohol material sealed around one or more chemical additives. Alternately, the downhole chemical additive is in a solid geometric shape and the water soluble polyvinyl alcohol comprises a film adhering to the solid. Additionally, the water dispersible container is a matrix comprising a mixture of downhole chemical additive and polyvinyl alcohol. The matrix is formed onto a substrate.

In this preferred embodiment, the present invention provides an apparatus for the controlled release of corrosion inhibitors, oxygen scavengers or biocides.

Preferably, the container comprises a polyvinyl alcohol. Depending on temperature conditions in the piping or wellbore, the polyvinyl alcohol can be a short-chained cold water soluble polyvinyl alcohol used in shallow wells, a long-chained hot water soluble polyvinyl alcohol for deep wells or vinyl alcohol co-polymer preferred in high temperature conditions. Again, the structure of the container can vary from a pouch like container, to a film surrounding a solid or a matrix.

In one preferred method for the controlled release of downhole chemical additives, a polyvinyl alcohol pouch can be filled with one or more downhole chemical additives. The pouch is sealed and then placed in any pipe or tank containing fluids to be circulated through a well bore. The polyvinyl alcohol can be selected from long-chained hot water soluble polyvinyl alcohol, short-chained cold water soluble polyvinyl alcohol or vinyl alcohol co-polymers. Alternatively, the pouch may be secured within a cap for a subsea well bore. In alternate embodiment, the pouch may be secured on the cap by placing the pouch within a basket or by another attachment means, for example taping, gluing, hooking or using looping attachments and combinations thereof within the cap.

### BRIEF DESCRIPTION OF DRAWINGS

FIG. 1a illustrates a top view of one embodiment of this invention with a cut-a-way to show chemical additive within the container.

FIG. 1b illustrates a side view of one embodiment of this invention.

FIG. 2a illustrates a top view of another embodiment of this invention.

FIG. 2b illustrates a side view of another embodiment of this invention.

FIG. 3 illustrates a cross section of still another embodiment of this invention.

### DETAILED DESCRIPTION OF THE INVENTION

The release of chemical additives within downhole wells, storage tanks and the extensive metal piping connected to wells must be controlled to prevent spiking of the additive within the well, tank or pipe fluids as well as untimely deprivation of critical additives. As the length of well bores and piping to wells increases, for example in horizontal drilling or deep sea drilling, the time for delivering chemicals down long wellbores or piping to the well can range from 2 to 200 hours. Chemicals must survive the passage through hoses and piping that may extend for miles. The integrity of the chemical additives can be jeopardized during this time and production shut down if the chemicals are untimely released.

The apparatus of this invention is a water dispersible container for chemical additives that delays the release of chemicals until the container has reached its targeted dispersion site. Chemical additives are used for a multitude of purposes: reduction of metal attackers by the use of corrosion inhibitors, oxygen scavengers and biocides, as tracers to follow the path of downhole fluids, as plugging agents, or as scale or hydrate inhibitors, to name a few uses.

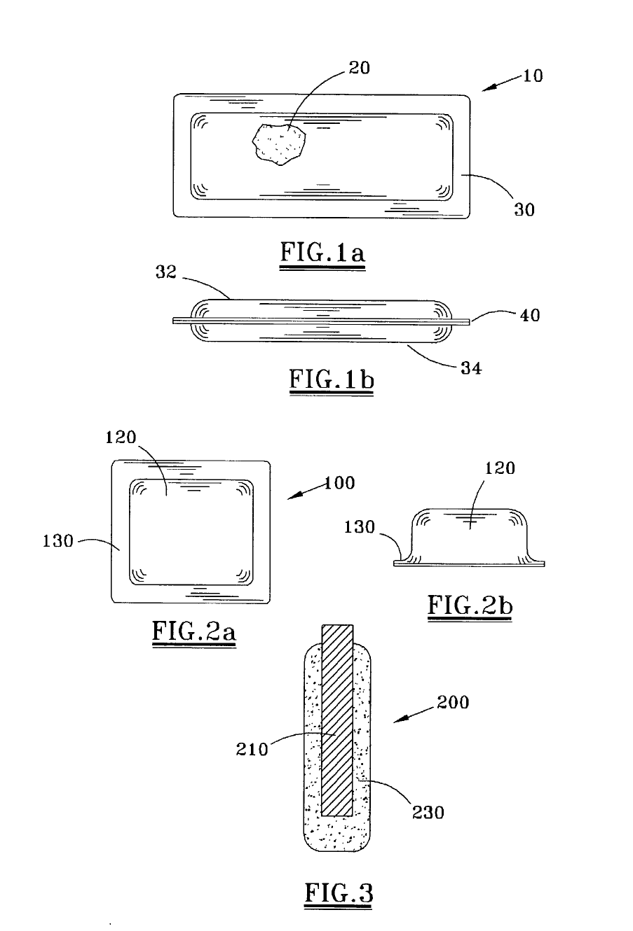

In one embodiment of the apparatus for the controlled release of downhole chemical additives 10, as illustrated in FIGS. 1a and 1b, the apparatus comprises one or more downhole chemical additives 20 within a container 30. The wellbores and piping usually contain aqueous fluids, sea water or fresh water for example. In this embodiment, the container 30 is water dispersible. The water dispersible container 30 is semi-permeable to allow water to enter into it 30. Dispersion of the container 30 is by permeation. As the water mixes with the chemical additives and fills the container, the container swells to the point of bursting the water dispersible material. Upon bursting, the material disperses into small particles thereby releasing the chemical additives within the container. This dispersion takes place over a period of time, depending on temperature and pressure conditions, typically from 2 hours to 200 hours.

In one embodiment, the material of the dispersible container is comprised of polyvinyl alcohol chains, typically in the form of a film. Selection of the composition of the water dispersible container-material is dependent upon the environment in which it is placed and the chemical additive contained within. The release of the chemical additive is controlled by the type of polyvinyl alcohol chain used as the material for the container. The selection of a specific polyvinyl alcohol chain depends on several factors: 1) the temperature conditions of the environment for the release, 2) the desired speed of release, and 3) the chemical release profile.

The polyvinyl alcohol chains vary in size. Polyvinyl alcohol selected for forming the container of this invention are based on industry standards comprising cold water soluble polyvinyl alcohols, hot water soluble polyvinyl alcohols, or vinyl alcohol co-polymers. Cold water soluble polyvinyl chains are typically short chains comprising a molecular weight of less than 10,000. Coldwater soluble polyvinyl alcohol is used for more immediate disbursement of chemicals in shallow well bores and on shore storage tanks subjected to cooler temperatures. Hot water soluble polyvinyl alcohol chains are longer chains having a molecular weigh greater than 50,000. Hot water soluble polyvinyl alcohol containers are soluble in the greater depths of offshore and deep wells where the temperature of the formation fluids is greater than 140° F. In luke-warm and cooler water temperature environments, ranging from about 50° F. to about 120° F., the hot water soluble polyvinyl alcohol chains disburse rather then dissolve, thereby slowing the release of the chemical additives. Therefore, in one preferred embodiment, hot water soluble polyvinyl alcohol is used to make the film for the containers comprising chemical additives that are to be released in a luke-warm water environment. In this embodiment, the release of chemical additives is controlled in the warm temperature waters by the dispersion of a hot water soluble polyvinyl alcohol container rather than the release by dissolution of the film. Dispersion of the long chained polyvinyl alcohol film or sheets can be delayed until the container reaches its destination within the desired temperature environment.

Referring to FIG. 1b, the water dispersible container 30 comprises a first sheet 32 of water dispersible material sealed to a second sheet 34 of water dispersible material. The seal 40 can be formed by heat welding. Depending on the application, other methods of sealing that are known in the art can also be used. In one preferred method of manufacturing the water dispersible container, the container is formed by sealing two sheets of polyvinyl alcohol film on three sides, leaving an opening on the fourth side. The container 10 is then filled with a chemical additive 20 and the fourth side is sealed so that the chemical additives are sealed within the cavity formed by the two sealed sheets. In one preferred embodiment for hot water soluble polyvinyl alcohol containers, 3 mil M 1030 polyvinyl alcohol film is obtained from Monosol, LLC. in sheet format and is cut to a size to form a container 10 suitable for specific applications. A cold water soluble polyvinyl alcohol film suitable for the container is E-6030 by Monosol LLC.

In another embodiment of the apparatus 100 of this invention, one or more dry downhole chemical additives are formed into a solid geometric shape 120, a tablet, a rectangle, or a sphere, for example. In this embodiment, the water dispersible polyvinyl alcohol comprises a film 130 that adheres to the solid chemical additive 120. The water dispersible polyvinyl alcohol contains a film formed onto the solid chemical additive. When the geometric apparatus 100 is placed in piping or downhole, the aqueous fluids swell the apparatus 100 causing the polyvinyl alcohol film 130 to burst into smaller particles and disperse. As the particles disperse, the chemical additive is released.

In still another embodiment of the apparatus of this invention, illustrated in FIG. 3, the water dispersible container 200 comprises a matrix 230 of a downhole chemical additive and polyvinyl alcohol formed onto a substrate 210. The substrate can embody a rod 210 as shown in FIG. 3, comprising metal, plastic or wood. Alternatively, the substrate can be in the form of another geometric shape. In one preferred embodiment, the liquid mixture of chemical additive and polyvinyl alcohol is coated onto a suitable substrate.

The chemical additives 30, 130, 230 can comprise corrosion inhibitors, oxygen scavengers, or biocides to prevent the degradation of metals found in well tanks and piping. Sea water containing chlorides and sulfates is especially corrosive. Since corrosion rates are influenced by the presence of dissolved oxygen, oxygen scavengers are frequently added to downhole fluids. Microbes metabolize metals or produce substrates that are corrosive. Other downhole chemical additives requiring controlled release downhole are selected from tracers, hydrate inhibitors, breakers, scale inhibitors, emulsion preventors, foamers, defoamers, temporary plugging agents, iron reducing agents, iron chelators, metal chelators, and combinations thereof.

In one preferred embodiment, the present invention provides an apparatus for the controlled release of down hole chemical additives, such as corrosion inhibitors, oxygen scavengers, or biocides enclosed within a water soluble container made from polyvinyl alcohol chains. The polyvinyl alcohol chains can be selected from cold water soluble polyvinyl alcohols, hot water soluble polyvinyl alcohols, or vinyl alcohol co-polymers, depending on the depth and downhole conditions of the wellbore and piping. Temperatures and atmospheric conditions of on shore wells, tanks and piping will determine the composition of the polyvinyl alcohol container. The water soluble polyvinyl alcohol containers can hold chemical additives comprising corrosion inhibitors, oxygen scavengers, biocides, tracers, hydrate inhibitors, breakers, scale inhibitors, emulsion preventors, foamers, defoamers, temporary plugging agents, iron reducing agents, iron chelators, metal chelators, or combinations thereof. The water soluble container may comprise a first sheet of water soluble material sealed to a second sheet of water soluble material with the down hole chemical additive contained between the first and second sheets. Alternatively, the water soluble container may comprise a down hole chemical additive in a block form, a tablet, rectangle, or sphere. In this embodiment, the water soluble polyvinyl alcohol is a film that adheres to the solid chemical additive. In still another alternative, the water soluble container is a matrix of one or more down hole chemical additives and polyvinyl alcohol polymers. The matrix is formed onto a substrate.

The present invention provides a method for the controlled release of downhole chemical additives. In one preferred method, a cold water soluble polyvinyl alcohol pouch is filled with one or more downhole chemical additives, the pouch is sealed, and placed in any pipe or tank that contains fluids to be circulated through a well bore. In this method, the polyvinyl alcohol pouch can be either water dispersible or water soluble. The one or more downhole chemical additives are selected from corrosion inhibitors, oxygen scavengers, biocides, tracers, hydrate inhibitors, breakers, scale inhibitors, emulsion preventors, foamers, defoamers, temporary plugging agents, iron reducing agents, iron chelators, metal chelators, or combinations thereof.

In another method of the present invention one or more downhole chemical additives are shaped into a solid geometric shape, such as a tablet, rectangle or sphere. The geometric block is then covered with a film of cold water soluble polyvinyl alcohol to form a water dispersible container. The container can then be placed in any pipe or tank that contains fluids to be circulated through a well bore.

Another method for the controlled release of downhole chemical additives includes forming a cold water soluble polyvinyl alcohol container for containing a downhole chemical additive by forming a matrix of the polyvinyl alcohol and the chemical additive around a substrate and then placing the container in any pipe or tank that contains fluids to be circulated through a well bore.

In a further method for the controlled release of downhole chemical additives, the present invention provides a method for filling a hot water soluble polyvinyl alcohol pouch with one or more downhole chemical additives, sealing the pouch and securing the pouch within a cap for a subsea well bore. The pouch may be secured on the cap by placing the pouch within a basket or another attachment means such as taping, gluing, hooking or using looping attachments and combinations thereof within the cap.

In a further method for the controlled release of downhole chemical additives, the present invention discloses for a method of forming a hot water soluble polyvinyl alcohol container by shaping a downhole chemical additive into a solid geometric shape and covering the solid with a film comprising hot water soluble polyvinyl alcohol and then securing the pouch within a cap for a subsea well bore. The pouch may be secured on the cap by placing the pouch within a basket or another attachment means within the cap.

The present invention provides another method for the controlled release of downhole chemical additives wherein a hot water soluble polyvinyl alcohol container that contains a downhole chemical additive is formed by forming a matrix of the polyvinyl alcohol and the chemical additive around a substrate and then securing the pouch within a cap for a subsea well bore. The pouch may be secured on the cap by placing the pouch within a basket or another attachment means within the cap.

### EXAMPLES

### Example 1

### Pouch Containing Sodium Erythorbate in Seawater at 65° F.

A 1″ wide by 4″ long pouch was formed by heat welding two sheets of 3 mil M 1030 polyvinyl alcohol film from Monosol, Inc. on three sides. The pouch was filled with 10 g of granular sodium erythorbate oxygen scavenger. The fourth side was heat welded to seal the pouch.

The sealed pouch was placed in a transparent cage to keep the pouch from floating. The cage containing the pouch was submerged in a 1000 ml beaker of seawater and observed versus time. The amount of sodium erythorbate remaining in the pouch at each observation time was noted as follows:

Sodium Erythorbate Dissolving Test at 65° F.

| | Percent of chemical |
|---|---|
| Hours | Remaining in pouch |
| 0 | 100% |
| 2 | 100% |
| 17 | 33% |
| 23 | 20% |
| 40 | 17% |

In this test example, the pouch remained essentially intact for more than two hours and then its contents slowly dissolved over time. Therefore, this pouch was suitable for delivering oxygen scavenger to an undersea wellhead by means of transport in an open well cap.

### Example 2

### Pouch Containing Sodium Erythorbate in Seawater at 40° F.

Another 1″ wide by 4″ long pouch containing granular sodium erythorbate was fabricated as in Example 1. The sealed pouch was placed in a transparent cage and the cage was submerged in a 1000 ml beaker of seawater. The beaker of seawater was refrigerated to 40° F. Periodically the beaker was removed from the refrigerator for observation to give the following results:

Sodium Erythorbate Dissolving Test at 40° F.

| | Percent of chemical |
|---|---|
| Hours | Remaining in the pouch |
| 0 | 100% |
| 3 | 95% |
| 72 | 33% |
| 96 | 25% |
| 120 | 20% |
| 144 | 15% |
| 168 | 15% |
| 240 | 10% |

This test shows that colder seawater slowed but did not prevent release of the pouch contents. Therefore, this pouch was suitable for placement of an oxygen scavenger in deep water subsea environments where the water temperatures approach 40° F.

### EXAMPLE 3

### Pouch Containing Liquid Corrosion Inhibitor in Seawater at 40° F.

A 1″ long pouch made of polyvinyl alcohol film was fabricated as in example 1 and 2 except this pouch was filled with a liquid corrosion inhibitor. The liquid corrosion inhibitor is commercially available as EC1120A from Nalco/Exxon Energy Chemicals.

The pouch was placed in the transparent cage and submerged in a 1000 ml beaker of seawater. The beaker was refrigerated to 40° F. and periodically removed for observation. It was visibly clear that the dark brown corrosion inhibitor migrated from inside the pouch to the rest of the beaker. Visual assessment of the pouch and beaker gave the following results:

Corrosion Inhibitor Dispersion Test at 40° F.

| | Percent of chemical |
|---|---|
| Hours | Remaining in the pouch |
| 0 | 100% |
| 3 | 100% |
| 72 | 90% |
| 96 | 80% |
| 120 | 70% |
| 144 | 60% |
| 168 | 50% |
| 240 | 33% |

This test showed that the pouch was suitable for placement of corrosion inhibitor in deep water subsea environments where the water temperatures approach 40° F.

### EXAMPLE 4

### Formation of Matrix Coating

A matrix coating of a water dispersible container comprised a liquid mixture of an oilfield chemical with polyvinyl alcohol. The matrix mixture was coated onto a suitable substrate. The matrix was formed as follows:

a. 1 g Celvol 350 (from Celanese Chemicals) polyvinyl alcohol was added to 10 ml water.

b. The resulting mixture was heated and mixed until it dissolved (at about 180° F.

c. The heating was stopped and 2.0 g sodium erythorbate was added.

d. The resulting mixture from step c was continually mixed until the sodium erythorbate was dissolved.

A thick, clear solution was formed.

The thick, clear coating solution was used to coat a glass stirring rod by alternately dipping the rod into the solution and blowing the rod dry with a hot air gun. This process was repeated about 25 times to form a 1/16 inch thick matrix on the rod.

### EXAMPLE 5

### Testing Solubility of Matrix Coating

The matrix coated rod formed in Example 5 was immersed in seawater at 65° F. After about one hour the coating became swollen and dropped off the glass rod. This test demonstrated that the coating technique could be used to make a polyvinyl alcohol and chemical matrix coating on a substrate that would be suitable fixtures in an oil well application.

The foregoing description is illustrative and explanatory of preferred embodiments of the invention, and variations in the size, shape, materials and other details will become apparent to those skilled in the art. It is intended that all such variations and modifications which fall within the scope or spirit of the appended claims be embraced thereby.

1. An apparatus for the controlled release of downhole chemical additives, the apparatus comprising:
one or more downhole chemical additives enclosed within a water dispersible container.

2. The apparatus of claim 1 wherein the one or more downhole chemical additives comprise a corrosion inhibitor.

3. The apparatus of claim 1 wherein the one or more downhole chemical additives comprise an oxygen scavenger.

4. The apparatus of claim 1 wherein the one or more downhole chemical additives comprise a biocide.

5. The apparatus of claim 1 wherein the one or more downhole chemical additives is selected from tracers, hydrate inhibitors, breakers, scale inhibitors, emulsion preventers, foamers, defoamers, temporary plugging agents, iron reducing agents, iron chelators, metal chelators, or combinations thereof.

6. The apparatus of claim 1 wherein the water dispersible container comprises polyvinyl alcohol chains.

7. The apparatus of claim 1 wherein the water dispersible container comprises cold water soluble polyvinyl alcohol.

8. The apparatus of claim 1 wherein the water dispersible container comprises hot water soluble polyvinyl alcohol.

9. The apparatus of claim 1 wherein the water dispersible container comprises vinyl alcohol co-polymers.

10. The apparatus of claim 1 wherein the water dispersible container comprises a first sheet of water dispersible material sealed to a second sheet of water dispersible material and the downhole chemical additive is contained between the first and second sheets.

11. The apparatus of claim 1 wherein the downhole chemical additive is in a solid geometric shape and the water dispersible polyvinyl alcohol comprises a film formed onto the solid chemical additive.

12. The apparatus of claim 1 wherein the shape of the solid chemical additive is selected from a tablet, a rectangle or a sphere.

13. The apparatus of claim 1 wherein the water dispersible container is a matrix comprised of a downhole chemical additive and polyvinyl alcohol, the matrix formed onto a substrate.

14. The apparatus of claim 13 wherein the substrate comprises a rod.

15. An apparatus for the controlled release of downhole chemical additives, the apparatus comprising:
one or more downhole chemical additives enclosed within a water soluble polyvinyl alcohol container.

16. The apparatus of claim 15 wherein the one or more downhole chemical additives comprise a corrosion inhibitor.

17. The apparatus of claim 15 wherein the one or more downhole chemical additives comprise an oxygen scavenger.

18. The apparatus of claim 15 wherein the one or more downhole chemical additives comprise a biocide.

19. The apparatus of claim 15 wherein the one or more downhole chemical additives is selected from tracers, hydrate inhibitors, breakers, scale inhibitors, emulsion preventers, foamers, defoamers, temporary plugging agents, iron reducing agents, iron chelators, metal chelators, and combinations thereof.

20. The apparatus of claim 15 wherein the water soluble container is a cold water soluble polyvinyl alcohol.

21. The apparatus of claim 15 wherein the water soluble container is a hot water soluble polyvinyl alcohol.

22. The apparatus of claim 16 wherein the water soluble container comprises vinyl alcohol co-polymers.

23. The apparatus of claim 15 wherein the water soluble container comprises a first sheet of water soluble material sealed to a second sheet of water soluble material and the downhole chemical additive is contained between the first and second sheets.

24. The apparatus of claim 15 wherein the downhole chemical additive is in a solid geometric shape and the water soluble polyvinyl alcohol comprises a film formed onto the solid chemical additive.

25. The apparatus of claim 26 wherein the shape of the solid chemical additive is selected from a group comprising a tablet, a rectangle and a sphere.

26. The apparatus of claim 15 wherein the water soluble container is a matrix comprised of a downhole chemical additive and polyvinyl alcohol, the matrix formed onto a substrate.

27. The apparatus of claim 26 wherein the substrate comprises rod.

28. An apparatus for the controlled release of downhole chemical additives, the apparatus comprising:
a corrosion inhibitor enclosed within a hot water soluble polyvinyl alcohol container.

29. The apparatus of claim 28 wherein the hot water soluble polyvinyl alcohol container comprises a first sheet of water soluble material sealed to a second sheet of water soluble material and the corrosion inhibitor is contained between the first and second sheets.

30. The apparatus of claim 28 wherein the corrosion inhibitor is in a solid geometric shape and the hot water soluble polyvinyl alcohol comprises a film formed onto the geometric shape.

31. The apparatus of claim 30 wherein the shape of the solid chemical additive is selected from a tablet, a rectangle and a sphere.

32. The apparatus of claim 28 wherein the water soluble container is a matrix comprised of a downhole chemical additive and polyvinyl alcohol, the matrix formed onto a substrate.

33. An apparatus for the controlled release of downhole chemical additives, the apparatus comprising:
a corrosion inhibitor enclosed within a hot water soluble polyvinyl alcohol container comprising a first sheet of water soluble polyvinyl alcohol material sealed to a second sheet of water soluble polyvinyl alcohol material and the corrosion inhibitor is contained between the first and second sheets.

34. An apparatus for the controlled release of downhole chemical additives, the apparatus comprising:
an oxygen scavenger enclosed within a water soluble polyvinyl alcohol container.

35. An apparatus for the controlled release of downhole chemical additives, the apparatus comprising:
a downhole biocide enclosed within a water soluble polyvinyl alcohol container.

36. An apparatus for the controlled release of downhole chemical additives, the apparatus comprising:
a downhole chemical additive, selected from a group consisting of a corrosion inhibitor, an oxygen scavenger, a biocide and combinations thereof, enclosed within a water soluble polyvinyl alcohol container.

37. An apparatus for the controlled release of downhole chemical additives, the apparatus comprising:
a downhole chemical additive, selected from a group consisting of a corrosion inhibitor, an oxygen scavenger, a biocide and combinations thereof, enclosed within a hot water soluble polyvinyl alcohol container.

38. A method for the controlled release of downhole chemical additives comprising:
a) filling a cold water soluble polyvinyl alcohol pouch with one or more downhole chemical additives;
b) sealing the pouch;
c) placing the pouch in any pipe or tank that contains fluids to be circulated through a well bore.

39. The method of claim 38 wherein the one or more downhole chemical additives is selected from a corrosion inhibitor, an oxygen scavenger, a biocide or combinations thereof.

40. The method of claim 38 wherein the one or more downhole chemical additives are selected from tracers, hydrate inhibitors, breakers, scale inhibitors, emulsion preventers, foamers, defoamers, temporary plugging agents, iron reducing agents, iron chelators, metal chelators, or combinations thereof.

41. A method for the controlled release of downhole chemical additives comprising:
a) forming a cold water soluble polyvinyl alcohol container by shaping one or more downhole chemical additives into a solid geometric shape and covering the solid with a film comprising hot water soluble polyvinyl alcohol;
b) placing the container in any pipe or tank that contains fluids to be circulated through a well bore

42. The method of claim 41 wherein the geometric shape of the solid chemical additive is selected from a tablet, a rectangle or a sphere.

43. A method for the controlled release of downhole chemical additives comprising:
a) forming a cold water soluble polyvinyl alcohol container for containing a downhole chemical additive by forming a matrix of the polyvinyl alcohol and the chemical additive around a substrate;
b) placing the container in any pipe or tank that contains fluids to be circulated through a well bore.

44. A method for the controlled release of downhole chemical additives comprising:
a) filling a hot water soluble polyvinyl alcohol pouch with one or more downhole chemical additives;
b) sealing the pouch;
c) securing the pouch within a cap for a subsea well bore.

45. The method of claim 44 wherein the one or more downhole chemical additives is selected from a corrosion inhibitor, an oxygen scavenger, a biocide or combinations thereof.

46. The method of claim 44 wherein the one or more downhole chemical additives is selected from tracers, hydrate inhibitors, breakers, scale inhibitors, emulsion preventers, foamers, defoamers, temporary plugging agents, iron reducing agents, iron chelators, metal chelators, or combinations thereof.

47. The method of claim 44 wherein the step of securing the pouch within the cap comprises placing the pouch within a basket within the cap.

48. The method of claim 44 wherein the step of securing the pouch within the cap comprises attaching the pouch to the cap with an attachment means.

49. The method of claim 48 wherein the attachment means is selected from tape, glue, hook and loop attachments and combinations thereof.

50. A method for the controlled release of downhole chemical additives comprising:
a) forming a hot water soluble polyvinyl alcohol container by shaping one or more downhole chemical additives into a solid geometric shape and covering the solid with a film comprising hot water soluble polyvinyl alcohol;
b) securing the pouch within a cap for a subsea well bore.

51. The method of claim 50 wherein the hot water soluble polyvinyl alcohol container further comprises long chain polyvinyl alcohol comprising a molecular weight greater than 50,000..

52. The method of claim 50 wherein the downhole chemical additives is selected from a corrosion inhibitor, an oxygen scavenger, a biocide or combinations thereof.

53. The method of claim 50 wherein the downhole chemical additives are selected from tracers, hydrate inhibitors, breakers, scale inhibitors, emulsion preventers, foamers, defoamers, temporary plugging agents, iron reducing agents, iron chelators, metal chelators, or combinations thereof.

54. The method of claim 50 wherein the step of securing the container within the cap comprises placing the container within a basket within the cap.

55. The method of claim 50 wherein the step of securing the container within the cap comprises attaching the container to the cap with an attachment means.

56. A method for the controlled release of downhole chemical additives comprising:
a) forming a hot water soluble polyvinyl alcohol container for containing a downhole chemical additive by forming a matrix of the polyvinyl alcohol and the chemical additive around a substrate;
b) securing the pouch within a cap for a subsea well bore.

57. The method of claim 56 wherein the step of securing the container within the cap comprises placing the container within a basket within the cap.

58. The method of claim 56 wherein the step of securing the container within the cap comprises attaching the container to the cap with an attachment means.
